(19) United States
(12) Patent Application Publication
(10) Pub. No.: US 2025/0200538 A1
(43) Pub. Date: Jun. 19, 2025

(54) P2P OR P2M MONEY TRANSFER FOR RESERVING GOODS AND SERVICES

(71) Applicant: Michael Vittone, San Pedro, CA (US)

(72) Inventor: Michael Vittone, San Pedro, CA (US)

(21) Appl. No.: 18/545,809

(22) Filed: Dec. 19, 2023

(51) Int. Cl. G06Q 20/10; G06Q 20/22; G06Q 20/32

(52) U.S. Cl. CPC G06Q 20/10; G06Q 20/227; G06Q 20/3223

(57) ABSTRACT

According to an aspect of the present invention, there is a provided computer-implemented method of electronically reserving a product or service, comprising: receiving, at a product or service provider electronic device, reservation pricing information for one or more products or services; presenting, at a customer electronic device, the reservation pricing information; receiving, at the customer electronic device, a selection of one or more of the one or more products or services to be reserved; receiving, at the customer electronic device, payment information; executing a payment transaction based on the payment information; notifying the product or service provider electronic device of the payment; and performing one or more of holding the payment amount in escrow and transferring some or all of the payment amount to the product or service provider cryptocurrency-related account, checking, savings, or debit transaction account, credit transaction account, and/or e-wallet and the like accounts.

### BACKGROUND

There are many services that make P2P and P2M payments possible, such as Venmo, Zelle, PayPal, Cash App, and the like. Often, payments are made in advance of performance of services or delivery of goods. However, it may be difficult to get paid back if the goods or services are not delivered.

Various solutions have been proposed in the prior art patent literature. For example, U.S. Pat. No. 8,630,896 discloses methods, computer readable media and systems wherein a security deposit is used to facilitate a transaction with a customer. In an embodiment, a process includes receiving an indication that a customer is interested in making a purchase during a transaction from a merchant, and transmitting an offer for a benefit to be applied to the transaction in exchange for a future performance of a task by the customer and a security deposit.

US20120259685 discloses a pre-paid transaction manager including a vendor module that includes a plurality of vendor accounts for a plurality of vendors. Each of the plurality of vendors has at least one of the plurality of vendor accounts. The vendor module receives a plurality of offers from the plurality of vendors. Each of the plurality of offers is associated with respective offer settings. The pre-paid transaction manager also includes a consumer module that includes a plurality of consumer accounts for a plurality of consumers. The consumer module presents one or more offers from a first vendor in the plurality of vendors to a consumer when the consumer selects the first vendor. The pre-paid transaction manager also includes an offer qualification engine to determine whether a deposit of funds received from the consumer qualifies the consumer for an offer from the first vendor using the respective offer settings of the offer. The pre-paid transaction manager may credit a consumer account for the consumer with the deposit of funds and a bonus associated with the offer if the offer qualification engine determines that the deposit of funds received from the consumer qualifies the consumer for the offer from the first vendor.

Nevertheless, convenient electronic payment systems and methods incorporating features configured for reservations of goods and services are still needed.

### SUMMARY OF INVENTION

Therefore, the present invention is a computer payment system with a reservation feature.

According to an aspect of the present invention, there is a provided computer-implemented method of electronically reserving a product or service, comprising: receiving, at a product or service provider electronic device, reservation pricing information for one or more products or services; presenting, at a customer electronic device, the reservation pricing information; receiving, at the customer electronic device, a selection of one or more of the one or more products or services to be reserved; receiving, at the customer electronic device, payment information; executing a payment transaction based on the payment information; notifying the product or service provider electronic device of the payment; and performing one or more of holding the payment amount in escrow and transferring some or all of the payment amount to the product or service provider in domestic or foreign currencies, crypto currencies, legal tender, checking, savings, debit transaction accounts, credit transaction accounts, e-wallets and the like accounts through an application on a mobile device or/and communication device that will facilitate such process for present and future or/and recurring dates.

### BRIEF DESCRIPTION OF THE DRAWINGS

FIG. 1 illustrates a flow chart for a first process according to an embodiment of the present invention.

FIG. 2 illustrates a flow chart for a second post-transaction process according to an embodiment of the present invention.

### DETAILED DESCRIPTION

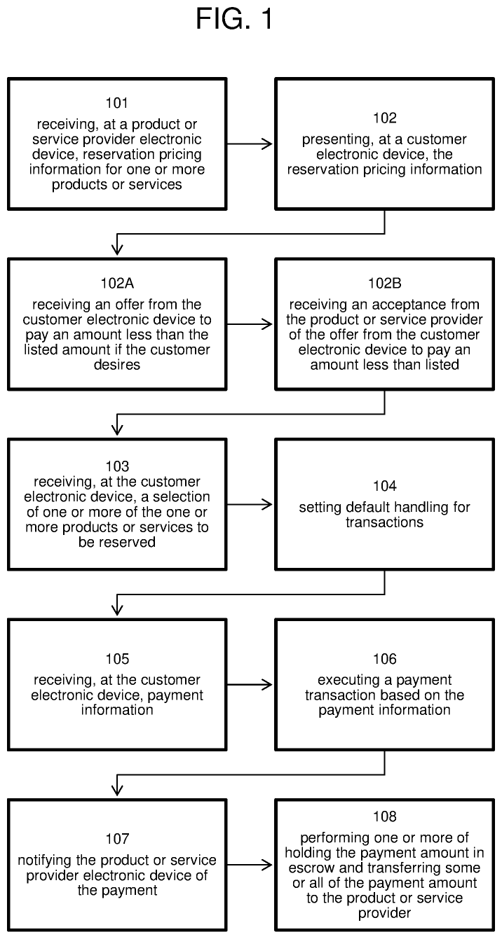

The following steps for initiating a transaction are illustrated in FIG. 1 in the attached drawings.

Step 101 is receiving, at a product or service provider electronic device, reservation pricing information for one or more products or services.

Step 102 is presenting, at a customer electronic device, the reservation pricing information.

Step 102A is optional and is receiving an offer from the customer electronic device to pay an amount less than the listed amount if the customer desires.

Step 102B is receiving an acceptance from the product or service provider of the offer from the customer electronic device to pay an amount less than the listed amount.

Step 103 is receiving, at the customer electronic device, a selection of one or more of the one or more products or services to be reserved.

Step 104 is setting default handling for transactions. For example, if no further input is received, the transaction could be closed. Or the customer's financial account could be charged automatically, or the merchant's account could be debited for a refund to the customer, all depending on the nature of the goods or services and the preferences of the customer and the merchant, among other factors.

Step 105 is receiving, at the customer electronic device, payment information.

Step 106 is executing a payment transaction based on the payment information.

Step 107 is notifying the product or service provider electronic device of the payment.

Step 108 is performing one or more of holding the payment amount in escrow and transferring some or all of the payment amount to the product or service provider in domestic or foreign currencies or crypto currencies, to checking, savings, or debit transaction accounts, credit transaction accounts, e-wallets or similar accounts through an application on a mobile device or communication device that will facilitate such process for present and future or recurring dates.

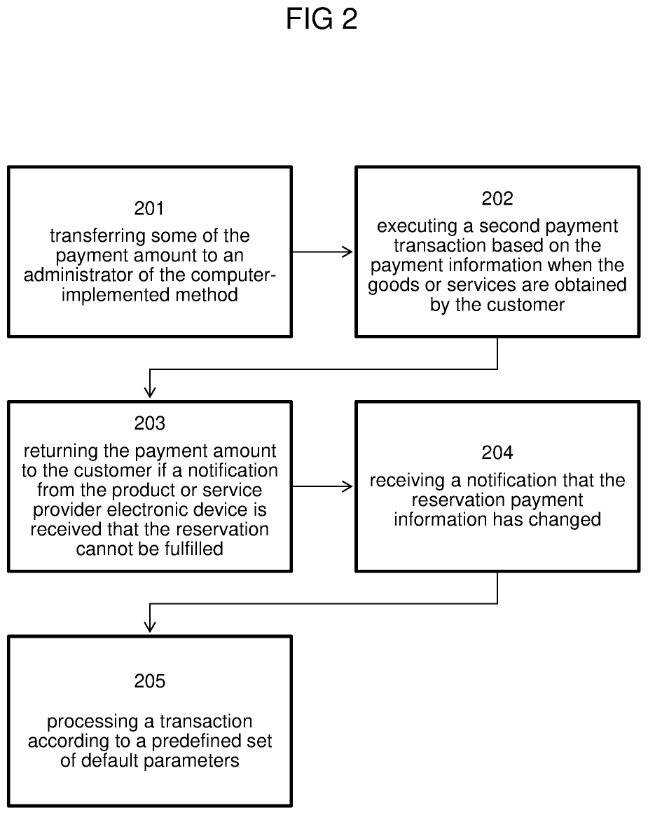

The following steps are options for post-transaction steps illustrated in FIG. 2 in the attached drawings.

Step 201 is optionally transferring some of the payment amount to an administrator of the computer-implemented method.

Step 202 is executing a second payment transaction based on the payment information when the goods or services are obtained by the customer.

Step 203 is returning the payment amount to the customer if a notification from the product or service provider electronic device is received that the reservation cannot be fulfilled.

Step 204 is receiving a notification that the reservation payment information has changed, from the product or service provider electronic device; sending a notification to the customer electronic device of the revised reservation payment information; and sending or receiving an adjustment payment to or from an account indicated by the customer payment information.

Step 205 is processing a transaction according to a predefined set of default parameters as described with reference to Step 104 in FIG. 1.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Similar numerals designate similar elements among the several figures. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A computer-implemented method of electronically reserving a product or service, comprising:
receiving, at a product or service provider electronic device, reservation pricing information for one or more products or services;
presenting, at a customer electronic device, the reservation pricing information;
receiving, at the customer electronic device, a selection of one or more of the one or more products or services to be reserved;
receiving, at the customer electronic device, payment information;
executing a payment transaction based on the payment information;
notifying the product or service provider electronic device of the payment;
and performing one or more of holding the payment amount in escrow and transferring some or all of the payment amount to the product or service provider cryptocurrency-related account, checking, savings, debit transaction account, credit transaction account, or e-wallets account.

2. The method of claim 1, further comprising transferring some of the payment amount to an administrator of the computer-implemented method.

3. The method of claim 1, further comprising executing a second payment transaction based on the payment information when the goods or services are obtained by the customer.

4. The method of claim 1, wherein the customer electronic device is a smartphone.

5. The method of claim 1, wherein the payment information is one or more of cryptocurrency-related data, checking, savings, debit transaction accounts, credit transaction accounts, e-wallets and the like accounts.

6. The method of claim 1, further comprising returning the payment amount to the customer upon receiving a notification from the product or service provider electronic device that the reservation cannot be fulfilled.

7. The method of claim 1, further comprising:
receiving a notification that the reservation payment information has changed, from the product or service provider electronic device;
sending a notification to the customer electronic device of the revised reservation payment information; and
sending or receiving an adjustment payment to or from an account indicated by the customer payment information.

8. The method of claim 1, further comprising receiving an offer from the customer electronic device to pay an amount less than the listed amount.

9. The method of claim 8, further comprising receiving an acceptance from the product or service provider of the offer.

10. The method of claim 1, further comprising processing a transaction according to a predefined set of default parameters.
